(19) United States
(12) Patent Application Publication
(10) Pub. No.: US 2007/0004382 A1
(43) Pub. Date: Jan. 4, 2007

(54) Processing of incoming calls to a mobile station

(75) Inventor: Ilkka Haukilahti, Helsinki (FI)

Correspondence Address: OLIFF & BERRIDGE, PLC, P.O. BOX 19928, ALEXANDRIA, VA, 22320, US

(73) Assignee: Medianatum Oy, Helsinki (FI)

(21) Appl. No.: 10/554,590

(22) PCT Filed: May 14, 2004
(86) PCT No.: PCT/FI04/00295

§ 371 Date: Feb. 16, 2006

(30) Foreign Application Priority Data
May 15, 2003 (FI) 20030728

(51) Int. Cl. H04M 3/42; H04L 12/58

(52) U.S. Cl. 455/412.1; 379/211.01

(57) ABSTRACT

A technique for leaving automatic call requests. A switch (SW) receives (2-2) a call setup request from an A terminal to a B terminal and detects (2-4) that the B terminal cannot take the call. The switch (SW) informs (2-6) the A terminal that the call setup request can be interpreted as an automatic call request to the B terminal. Upon receiving (2-8) an acknowledgment from the A terminal, the switch determines and temporarily stores (2-14) an identity of the A terminal. It then sends (2-18) the B terminal a data message that comprises an automatic call request that indicates the identity of the A terminal.

### BACKGROUND OF THE INVENTION

The invention relates to methods and equipment for processing incoming calls to a mobile station when the mobile station is not able respond to the incoming call.

It is customary to employ answering service, ie voice mail, to which a calling party may leave a voice message in case the called party is busy. Conventional answering service involves certain problems, however. For instance, leaving the voice message and listening to it takes time. Also, some people do not like talking to a machine. Another problem of conventional voice mail is that the called party has to write or type the caller's telephone number, if that number is not stored in the telephone's address book.

### BRIEF DESCRIPTION OF THE INVENTION

An object of the present invention is to provide a method and an apparatus for implementing the method so as to alleviate the above disadvantages. The object of the invention is achieved by the methods and equipment which are characterized by what is stated in the independent claims. The preferred embodiments of the invention are disclosed in the dependent claims.

The invention is based on the idea that a fairly large share of voice messages are call requests, ie requests for the called party to return the call to the calling party. Such call requests can be processed automatically to mobile stations capable of processing data messages. As used herein, a ‘data message’ means a message that contains data which is understandable to a data processing equipment without speech-to-text conversion or the like. A nonexhaustive list of data messages comprises a short message, a wap message, a datagram in a packet network and the like.

An aspect of the invention is an automatic method for processing a call from a calling terminal (A) to a called terminal (B) that supports data messages. The method comprises the following steps, performed by a network element that controls the formation of calls. The network element may be a switching element in a telephone network, or it may be a service control element in an intelligent network. The following steps are described in the context of a switch, such as a mobile network service centre.

1. The switch receives a call setup request from the A terminal to the B terminal and detects that the called terminal cannot respond to the call setup request.

2. The switch informs the A terminal that the call setup request can be interpreted as an automatic call request to the B terminal and, preferably, sends information on how to place an automatic call request.

3. The switch receives an acknowledgment from the A terminal that that the terminal user wishes to leave an automatic call request.

4. The switch determines and temporarily stores an identity of the A terminal. At a minimum, the A terminal's identity (number) can be determined based on a calling line indicator (CLI). Preferably, the switch sends an inquiry to a data base or search engine, in order to convert the A terminal's number to a textual identity.

5. The switch then sends the A terminal a data message comprising the automatic call request. The automatic call request indicates the identity of the calling terminal.

In step 3, if the acknowledgment is not received, the call setup request may be routed to conventional voice mail.

In a further preferred embodiment, the A terminal user may be able to indicate that he/she accepts a reverse-charge call (collect call) from the B terminal.

Each data message may indicate identities of several calling terminals from which call setup requests were detected before the data message is sent. Thus, if the terminal is busy or switched off for long periods of time, it suffices to send only one data message. A further benefit gained by sending multiple A terminal identities in a single data message is that the B terminal is able to display several call requests on its screen simultaneously, even if the B terminal does not have any special software for combining call requests from multiple data messages.

In a further preferred embodiment, the called terminal includes a software agent for helping the user to manage multiple call requests. The software agent is able to displaying identities of several A terminals whose identities are indicated by one or more automatic call requests. The software agent receives the user's indication of a selected A terminal. In response to the user's indication, the software agent causes the terminal to place a call to the user-selected A terminal.

Yet another preferred embodiment comprises making an automatic callback call to the calling terminal. An automatic callback call to the calling terminal means that the user of the called terminal B does not have to control call setup manually in respect of each call request. Instead, a software agent in the terminal, or a corresponding service in a network element detects that the B user is ready to return calls. Such detection may be based on an explicit message from the B user that the software agent or service should return calls to all callers who left call requests. Or, the detection may be implicit, based on the detection that the B user's previous call was ended.

It is also preferable to monitor the status of pending call requests and, if an estimated waiting time is long, to send status information to callers who left call requests.

An advantage of the invention is that the calling user does not have to dictate of type call requests. Another advantage is that the called user does not have to type or write telephone numbers of callers. Instead, a network element that controls calls determines the caller's identity (at least number, and preferably name) and conveys the identity to the B terminal in a data message, which the B terminal can then parse as a telephone number or other identity suitable for placing calls.

### BRIEF DESCRIPTION OF THE DRAWINGS

In the following the invention will be described in greater detail by means of preferred embodiments with reference to the attached drawings, in which

FIG. 1 is a simplified view of a network architecture in which the invention can be used;

FIG. 2 is a signalling diagram illustrating a possible set of events in a system as shown in FIG. 1;

FIG. 3 illustrates an advanced terminal displaying multiple call request in a single display of its user interface; and

FIG. 4 shows a signalling diagram for an embodiment in which the software agent for responding to call requests is installed in the switching element.

### DETAILED DESCRIPTION OF PREFERRED EMBODIMENTS THE INVENTION

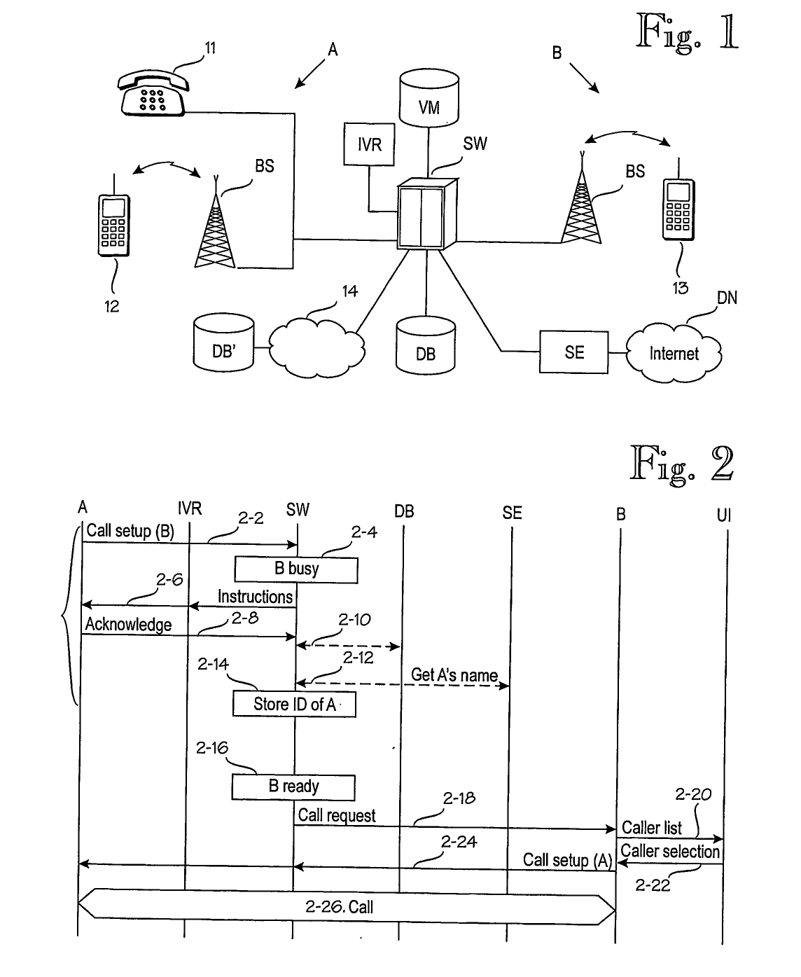

FIG. 1 shows a simplified network architecture in which the invention can be used. A switching element SW controls the switching of calls between a calling party A and a called party B. Depending on context, letters A and B may refer to actual persons or their terminals. FIG. 1 shows two types of A party terminals, namely a wired telephone 11 and a mobile terminal 12. The B party's terminal is mobile terminal 13. Mobility is not absolutely essential for the invention, but the ability to receive and process data messages is. The mobile terminals 12, 13 are served by base stations BS, but other intervening network elements are omitted for clarity. The switching element SW preferably comprises or is functionally coupled to a speech synthesizer for giving audible instructions to one or both parties. In this example the speech synthesizer is shown as an interactive voice response unit IVR. There is also a conventional voice mail service VM.

The switching element SW is preferably able to convert the calling party's telephone number to a textual name or identity. In order to do so, the switching element SW has access to various data bases and/or search engines. By way of example, FIG. 1 shows a data base DB that is owned by the same operator as the switching element SW and another data base DB' that is owned by an operator of a different network 14. There is also a search engine SE that is capable of searching one or more data network DN, such as the Internet, for a name that matches the calling party's telephone number.

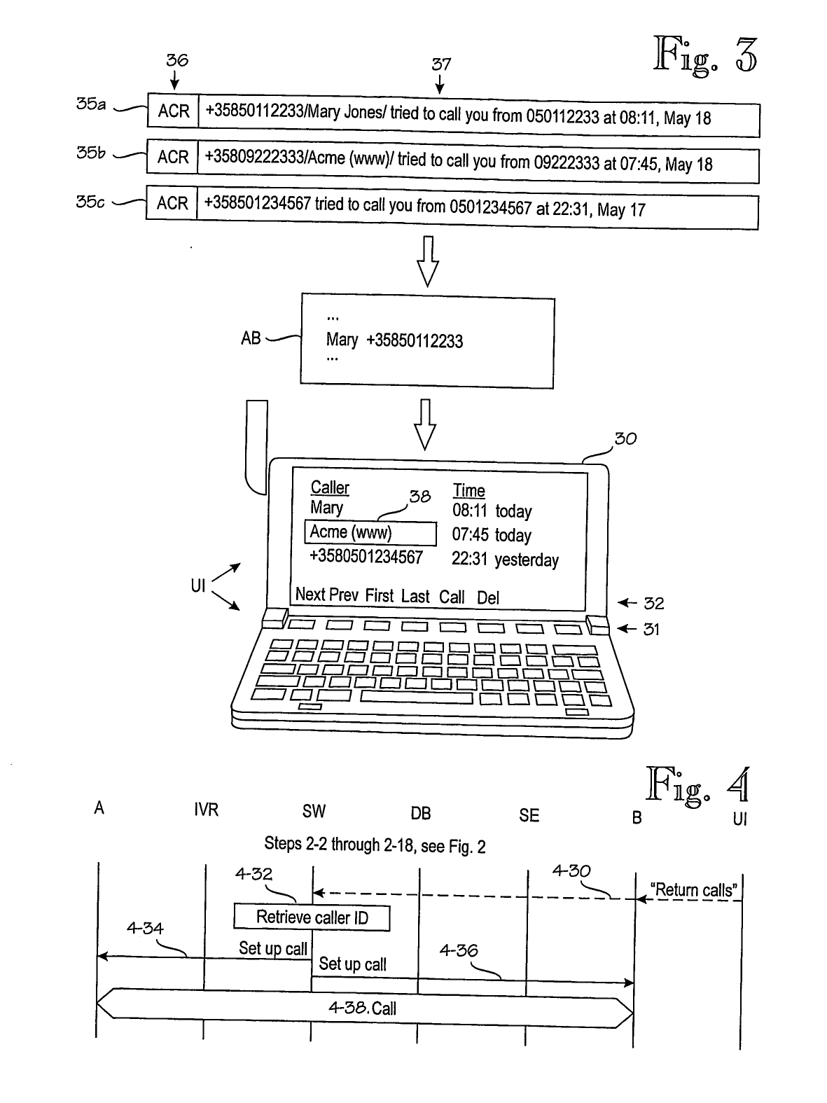

FIG. 2 is a signalling diagram illustrating a possible set of events in a system as shown in FIG. 1. Dashed lines indicate optional steps. Reference numeral 20 generally depicts a set of events that relate to one call attempt from a calling party A. In step 2-2 switching element SW receives a call setup request from the A party. The call setup request includes the B party's telephone number (or other network address). In step 24 the switching element SW detects that the B party is unable to take the call, either because the B terminal is busy, or out of network coverage, or the user simply does not answer. In any case, the switching element SW does not receive an off-hook signal from the direction of the B party. In step 2-6 the switching element SW sends, via the IVR unit in this example, a notification that the B party is unable to take the call and that the A party can leave an automatic call request. In this context, ‘automatic’ means that the A user does not have to type or speak a call request but only give a simple acknowledgment that the call setup request should be interpreted as an automatic call request. In step 2-8 the A user gives the requested acknowledgment. For example the instructions in step 2-6 may be something like: “the person you are trying to reach is unable to take the call right now. Please press ‘1’ to leave an automatic call request or ‘2’ to leave a voice mail message.” If the A user presses neither ‘1’ nor ‘2’, the call attempt terminates without the B user being informed in any way. But if the A user presses ‘1’, this is interpreted as an acknowledgment that the A user wishes to leave an automatic call request to the B party.

The dialog 2-6, 2-8, between the switching element SW and the caller A is shown as essential, ie with solid lines. This dialog is not strictly essential in a technical sense and is only required for telephone etiquette. This means that in many cases the caller must be able to decide whether to leave an automatic call request or not.

Note that the call setup request 2-2 must include or otherwise be associated with the A party's identity, such as a telephone number. Otherwise an automatic call request is meaningless. A common technique for this purpose is known as calling line identification, CLI.

Exemplary steps 2-10 and 2-12 relate to a preferred embodiment in which the switching element SW is able to convert the calling party's telephone number to a textual name or identity. In step 2-10 the switching element SW sends an inquiry to the local data base DB, but this query fails in that no matching textual name or identity is found. In step 2-12 switching element SW sends another inquiry, this time to the search engine SE, that searches Internet for web pages that match the A party's telephone number and parses a suitable web page to retrieve the A party's textual name. For example, assume that the A party's telephone number is ‘2221234’. In case of big firms, it is customary to assign telephone numbers out of a wide number space that begins on even hundred or thousand boundaries. If no perfect match is found, the search engine may repeat the search by replacing two or more last digits with zeros. Assume that number ‘2221000’ is found near the word ‘telephone’ (or its abbreviation) under “ww.acme.com”. Now the search engine may assume that the caller is from Acme company. If the caller calls as a private person, that is, from his/her personal telephone number, the data bases DB, DB′ or the search engine SE may not find a match, but in such cases it is possible that the terminal of the called party B may store a matching name in its address book.

In step 2-14 the switching element SW temporarily stores A's identity, that is, A's telephone number and the optionally retrieved textual identity. This step concludes the set of events 20 that relate to a single call attempt from a calling party A. The B party's terminal may be busy or switched off for a lengthy period of time, and the set of events 20 may be repeated for call attempts from several callers.

Steps 2-16 through 2-20 relate to conveying the call request to the called party. In an optional step 2-16, the switching element SW detects that the B party's terminal is ready to take calls. This step is optional, because in many signalling systems the switching element SW can send a data message without regard to the called terminal's readiness status. For example, if the data message is a GSM short message, it can be sent even if the B party's terminal is having an ongoing call. Also, if the B party's terminal is switched off, the switching element SW may send the short message, which is then stored in a Short Message Service Centre (not shown separately), until the B terminal is again connected to the network.

In step 2-18 the switching element SW sends the automatic call request to the called terminal B. Unlike a conventional voice message, the automatic call request is sent as a data message, whereby the called terminal B can interpret its contents without excessive processing, such as speech-to-text conversion. A simple embodiment of the data message is a GSM short message or its derivatives, such as an MMS (Multimedia Messaging Specification) message that can include sound or image attachments. If the B terminal supports WAP (Wireless Application Protocol), a WAP message can be used. In packet networks, a datagram can be used.

Each data message 2-18 may include one or more call requests. For example, if the B terminal is switched off for a long period of time, and several callers have opted to leave automatic call requests, it may be more convenient for the B user to have all automatic call requests sent in one suitably-formulated data message. This option is especially preferable if the B terminal includes special application software, such as a software agent, for processing (parsing) multiple call requests in a single message. On the other hand, if the B terminal is a bare-bones GSM handset, it may be more convenient for its user to receive each call request in a separate data message. In a simple handset there is probably a way to select one message out of many, and place a call to the number indicated by that message, but the simple handset may not be able to parse multiple caller identities of a message that includes several caller identities.

The data message 2-18 preferably. includes at least the following items:
1. an indication of an automatic call request
2. the date and time of the call attempt
3. the caller's telephone number
4. the caller's textual identity (if found by the DB/SE inquiry)

As to item 1, the indication of the automatic call request is preferably indicated by a well-formulated indicator, such as a specific bit pattern in a specific field. Such a well-formulated indicator helps the terminal software to interpret the data message as an automatic call request. But for users of dumb terminals, it is convenient to include a free-format text such as “(name) asked you to call to (number) at (date, time)”.

Even if the caller's textual identity is found by the DB/SE inquiry (steps 2-10, 2-12), the caller's telephone-number should be included in the call request for two purposes. An obvious reason is that the caller's telephone number is needed when the B user responds to the call request. Another reason is that the B terminal may also find a matching name in its own address book and override the name found by the data bases DB, DB′ or the search engine SE.

In step 2-20 the B terminal displays the call request. As stated above, a dumb terminal may simply show several short messages, of which the user may select and show one at a time. A more advanced terminal includes a software agent for helping the user to handle call requests. The terminal may activate the software agent automatically in response to receiving a data message that is interpreted as an automatic call request. This is why a well-formulated indicator of an automatic call request is beneficial. The software agent can combine relevant data from several call requests and display the data on a single screen on the terminal's user interface. Step 2-20 will be further illustrated in FIG. 3.

In step 2-22 the B terminal user selects a specific call request and wishes to place a call to the caller who left the call request. If the B terminal is a dumb terminal with only minimal capacity for processing short messages, the user opens a particular short message, after which he/she can use terminal functions like “pick number” and “call”. The actions in an advanced terminal will be illustrated in FIG. 3.

In step 2-24, the B terminal places a call, via the switching element SW, to the A terminal that left the automatic call request. In step 2-26 there is a conventional call between the parties.

FIG. 3 illustrates an advanced terminal 30 displaying multiple call request in a single display of its user interface UI. The user interface comprises a display device and an input device. The advanced terminal 30 comprises a software agent that is able to process multiple call requests and display their relevant data in a single display. In this example, the software agent is controlled by programmable function keys 31. The current function of each function key is displayed above the key. Alternatively, a stylus can be used instead of function keys.

The terminal 30 has received several data messages 35a to 35c. Each data message preferably comprises a well-defined message type field 36 that clearly indicates to the terminal software that the data message includes an automatic call request. In this example, the first three letters of the data message are ACR (for “automatic call request”). The actual contents 37 of message 35a includes the number from which the call request was received (+358050112233); the name of the caller (Mary Jones), as determined by a data base query, a verbal indication that the message is a call request to a certain number and the date/time at which the call request was received.

Reference sign AB denotes a sample from the terminal's address book. The address book AB includes an entry for Mary Jones, under the name of “Mary”. Because the telephone number of message 35a is found in the terminal's address book, the software agent overrides the name given by the data base, and the familiar name of “Mary” is displayed instead of “Mary Jones”.

The second data message 35b shows the caller's number as +35809222333. We assume, for the purposes of this example, that this number was found neither in the data base DB nor in the address book. But the search engine SE found a probable match at an Internet address www.acme.com. Accordingly, the caller's textual name may be indicated as “Acme (www)”. The caller of the third data record 35c is unknown to the address book, the data bases and to the search engine.

FIG. 3 shows the terminal 30 in a situation where the software agent shows the data for the three call requests 35a to 35c. The software agent is preferably activated automatically in response to receiving an automatic call request, such as a data message with a suitably formulated indicator field 36. In order not to consume display space, redundant information is avoided, such as the text “(x) tried to call you” and the caller's number, if a matching textual name is found, either by the terminal itself or by the data base or Internet search. The rectangle 38 depicts the selector of the software agent. As soon as the user presses the function key marked “Call”, the software causes the terminal to place a call to the number indicated by the corresponding data record.

If we assume that the terminal user wishes to respond to call requests in the order in which they were made, and that the software agent displays the call request data automatically, in response to receiving a call request, all the user has to do is press a single key in order to place a call the caller that left the call request. Instead or pressing a key, the terminal and its user can use alternative input means, such as speech recognition. For example, the user may teach the terminal to recognize commands like “up”, “down”, “delete” and “call”.

In order to further reduce the actions required to respond to call requests, the software agent can be set up so that it automatically attempts to place a call to each caller who left a call request. As soon as one call terminates, the next one is made without further user action.

FIG. 4 shows a signalling diagram for an embodiment in which the software agent for responding to call requests is installed in the switching element SW. In this embodiment the switching element SW has a more active role in returning calls. In addition to converting call attempts to automatic call requests, the switching element SW maintains a list of callers who opted to leave a call request. As soon as the switching element SW detects that the B user is ready to respond to the call requests, it automatically places callback calls to the one or more callers who left call requests.

In this scenario, steps 2-2 through 2-18 are performed similar to those shown in FIG. 2, and will not be described again. In step 4-30 the B user instructs the switching element SW to place calls to the callers who left call requests. This step is marked optional, because it is even possible to configure the service such that the switching element SW begins to return calls spontaneously, upon detecting that the B user can now take calls. In step 4-32 the switching element SW retrieves the first (eg the oldest) call request, and sets up a call to the caller indicated by the call request in step 4-34. In step 4-36 the switching element SW places call to the B user and combines the calls. In step 4-38 the A and B users have a conventional call. If a call between the users can be established, the corresponding call request is naturally deleted. Steps 4-32 to 4-38 are repeated for each pending call request.

In order to further improve the automatic callback service, the software agent in the terminal, or the corresponding function in the switching element, may periodically monitor the status of the call requests and send status information to the callers. For example: “there are n call requests before yours; average duration of calls is x minutes”.

It is readily apparent to a person skilled in the art that, as the technology advances, the inventive concept can be implemented in various ways. The invention and its embodiments are not limited to the examples described above but may vary within the scope of the claims.

1. An automatic method for processing a call from a calling terminal to a called terminal that supports data messages, the method comprising:
receiving a call setup request from the calling terminal to the called terminal and detecting that the called terminal cannot respond to the call setup request;
characterized by
informing the calling terminal that the call setup request can be interpreted as an automatic call request to the called terminals;
receiving an acknowledgment from the calling terminal that that the call setup request is to be interpreted as an automatic call request;
determining and temporarily storing an identity of the calling terminal;
sending the called terminal a data message comprising an automatic call request that indicates the identity of the calling terminal.

2. A method according to claim 1, characterized by determining a textual identity of the calling terminal.

3. A method according to claim 2, characterized by determining said textual identity by means of a search to a data network.

4. A method according to claim 1, characterized in that, if said acknowledgment is not received, the call setup request is routed to voice mail.

5. A method according to claim 2, characterized by receiving a notification that a user of the calling terminal accepts a reverse-charge call from the called terminal.

6. A method according to claim 1, characterized in that the data message indicates identities of several calling terminals from which call setup requests were detected before sending the data message.

7. A method according to claim 1, characterized by installing in the called terminal a software agent for:
displaying an identity of each of one or more calling terminals indicated by one or more automatic call requests;
receiving an indication of a user-selected calling terminal; and
placing a call to the user-selected calling terminal.

8. A method according to claim 1, further comprising making an automatic callback call to the calling terminal.

9. A method according to claim 1, further comprising determining status information on pending call requests and sending said status information to the calling terminal.

10. A switching elementary for a mobile network, operable to switch calls between mobile terminals, the switching element comprising means for receiving a call setup request from the calling terminal to the called terminals and detecting that the called terminals cannot respond to the call setup request;
characterized by
means for informing the calling terminal that the call setup request can be interpreted as an automatic call request to the called terminals;
means for receiving an acknowledgment from the calling terminal that that the call setup request is to be interpreted as an automatic call request;
means for determining and temporarily storing an identity of the calling terminal; and
means for sending the called terminals a data message comprising an automatic call request that indicates the identity of the calling terminal.

11. A mobile terminal for a mobile network, characterized by means for receiving and displaying an identity of each of one or more calling terminals indicated by one or more automatic call requests.

12. A mobile terminal according to claim 11, characterized by means for receiving an indication of a user-selected calling terminal and means for placing a call to the user-selected calling terminal.

13. A mobile terminal according to claim 11, characterized by means for automatically placing a callback call to one of said one or more calling terminals.
